(19) United States
(12) Patent Application Publication
(10) Pub. No.: US 2017/0178522 A1
(43) Pub. Date: Jun. 22, 2017

(54) INTERACTIVE EDUCATION DEVICE

(71) Applicant: YI-LING LIU, Keelung (TW)

(72) Inventor: YI-LING LIU, Keelung (TW)

(21) Appl. No.: 14/972,091

(22) Filed: Dec. 17, 2015

(51) Int. Cl. G09B 1/06; G09B 19/02; G09B 19/08; G09B 17/00

(52) U.S. Cl. CPC G09B 1/06; G09B 17/00; G09B 19/02; G09B 19/08

(57) ABSTRACT

An interactive education device comprises a first module and a second module. One side surface of the first module has a plurality of shaped areas. Each of the shaped areas has a first shape and arranged at a first predetermined position. The second module has a plurality of shaped blocks. Each of the shaped blocks has a second shape. The shaped blocks are respectively hollowed out a form of a written or printed character. The form of the written or printed character of each shaped block is different. The second shape is corresponding to the first shape. A tutee is assigned to put each of the shaped blocks at the corresponding shaped area based on the form of the written or printed character and the predetermined position assigned by a tutor.

### FIELD OF THE INVENTION

The present invention relates to an education device, and more particularly to an interactive education device applicable to children in kindergarten.

### BACKGROUND OF THE INVENTION

Because the cramming education is declined, the education is changed from one-way instilling to bringing out the internal motivation and fun of the children. Therefore, many education devices/tools are risen up.

However, lots of the education devices/tools are one-way teaching. For example, the kindergarten teacher teaches the children to memorize or learn English letters, Arabic numerals, or BoPoMoFo and the children write them on a paper. It may not achieve the effect of interaction. And further the education is drab and it easily makes the children lose the learning interests.

In view of the foregoing circumstances, the inventor has invested a lot of time to study the relevant knowledge, compare the pros and cons, research and develop related products. After quite many experiments and tests, the “interactive education device” of this invention is eventually launched to improve the foregoing shortcomings, to meet the public use.

### SUMMARY OF THE INVENTION

An objective of this invention is providing an interactive education device. When a tutor (such as a kindergarten teacher) teaches at least one tutee (such as a child) to put a shaped block to the shaped area, the tutee may find the shaped block first and then put it to the shaped area whose predetermined position is assigned by the tutor. It means that the tutee has preliminarily known the form of the written or printed character. It may achieved the effect of education (or teaching) and further enhance to memorize and learn the written or printed character (or the word) which the tutor wants to educate/teach.

To achieve above objectives, an interactive education device is disclosed. The interactive education device comprises a first module, one side surface thereof has a plurality of shaped areas, each of the shaped areas has a first shape and arranged at a first predetermined position; and a second module, having a plurality of shaped blocks, each of the shaped blocks has a second shape, the shaped blocks are respectively hollowed out a form of a written or printed character, the form of the written or printed character of each shaped block is different, and the second shape is corresponding to the first shape; wherein a tutee is assigned to put each of the shaped blocks at the corresponding shaped area based on the form of the written or printed character and the predetermined position assigned by a tutor.

In some embodiments, the form of the written or printed character is English letter, Arabic numeral, BoPoMoFo, or alphabets of different countries.

In some embodiments, the first shape is apple-shaped, star, or heart.

In some embodiments, a color pen is passed through the hollowed-out form of the written or printed character to color on the shaped area to form a word while the tutee is assigned to put each of the shaped blocks at the corresponding shaped area based on the form of the written or printed character and the predetermined position assigned by the tutor.

Further features and advantages of the present invention will become apparent to those of skill in the art in view of the detailed description of preferred embodiments which follows, when considered together with the attached drawings and claims.

### BRIEF DESCRIPTION OF THE DRAWINGS

All the objects, advantages, and novel features of the invention will become more apparent from the following detailed descriptions when taken in conjunction with the accompanying drawings.

FIG. 1 is a schematic drawing of a first module of a first embodiment of an interactive education device of the present invention.

FIG. 2 is a schematic drawing of a second module of the first embodiment of the interactive education device of the present invention while the form of the written or printed character is English letter.

FIG. 3 is a schematic drawing of the second module of the first embodiment of the interactive education device of the present invention while the form of the written or printed character is Arabic numeral.

FIG. 4 is a schematic drawing of the second module of the first embodiment of the interactive education device of the present invention while the form of the written or printed character is English letter and after the second module is interacted to the first module.

FIG. 5 is a schematic drawing of the second module of the first embodiment of the interactive education device of the present invention while the form of the written or printed character is Arabic numeral and after the second module is interacted to the first module.

FIG. 6 is a schematic drawing of FIG. 4 while a color pen is passed through the hollowed-out form of the written or printed character to color on the shaped area to form a word while the tutee is assigned to put each of the shaped blocks at the corresponding shaped area based on the form of the written or printed character and the predetermined position assigned by the tutor.

FIG. 7 is a schematic drawing of FIG. 5 while the color pen is passed through the hollowed-out form of the written or printed character to color on the shaped area to form a word while the tutee is assigned to put each of the shaped blocks at the corresponding shaped area based on the form of the written or printed character and the predetermined position assigned by the tutor.

FIG. 8 is an enlarged view of FIG. 4 while the form of the written or printed character is “A” which is partially colored.

FIG. 9 is a schematic drawing of the first module having different predetermined positions comparing to FIG. 6.

FIG. 10 is a schematic drawing of the first module having different predetermined positions comparing to FIG. 7.

FIG. 11 is a schematic drawing of the first module of a second embodiment of the interactive education device of the present invention.

FIG. 12 is a schematic drawing of the second module of the second embodiment of the interactive education device of the present invention while the form of the written or printed character is BoPoMoFo.

FIG. 13 is a schematic drawing of the second module of the second embodiment of the interactive education device of the present invention while the form of the written or printed character is BoPoMoFo and after the second module is interacted to the first module.

FIG. 14 is a schematic drawing of FIG. 13 while the color pen is passed through the hollowed-out form of the written or printed character to color on the shaped area to form a word while the tutee is assigned to put each of the shaped blocks at the corresponding shaped area based on the form of the written or printed character and the predetermined position assigned by the tutor.

### DESCRIPTION OF THE PREFERRED EMBODIMENT

Referring now to the drawings where like characteristics and features among the various figures are denoted by like reference characters.

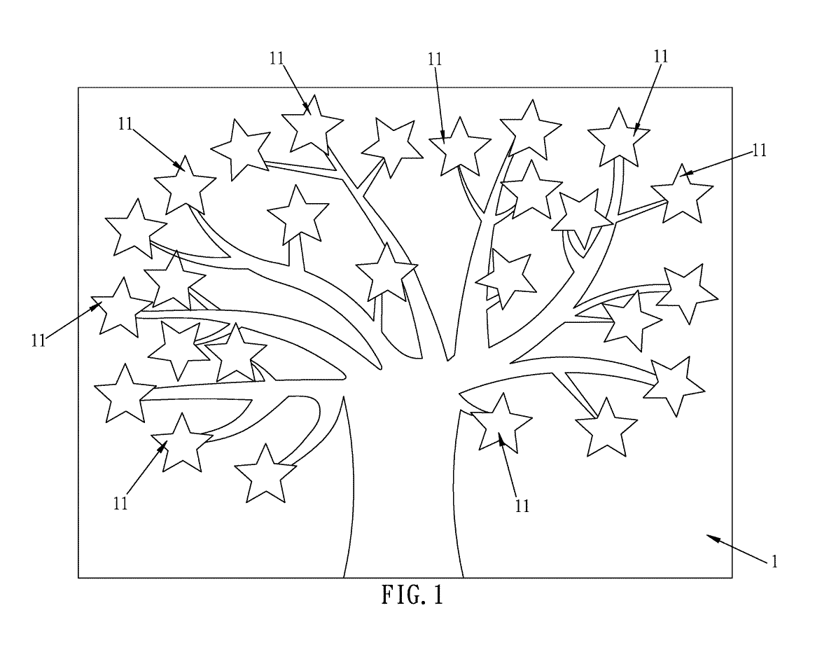

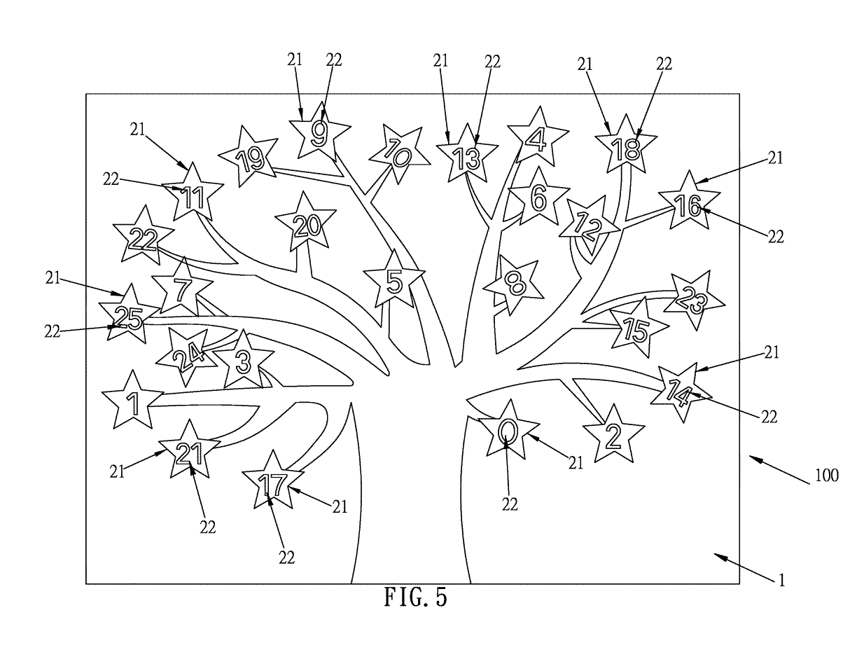

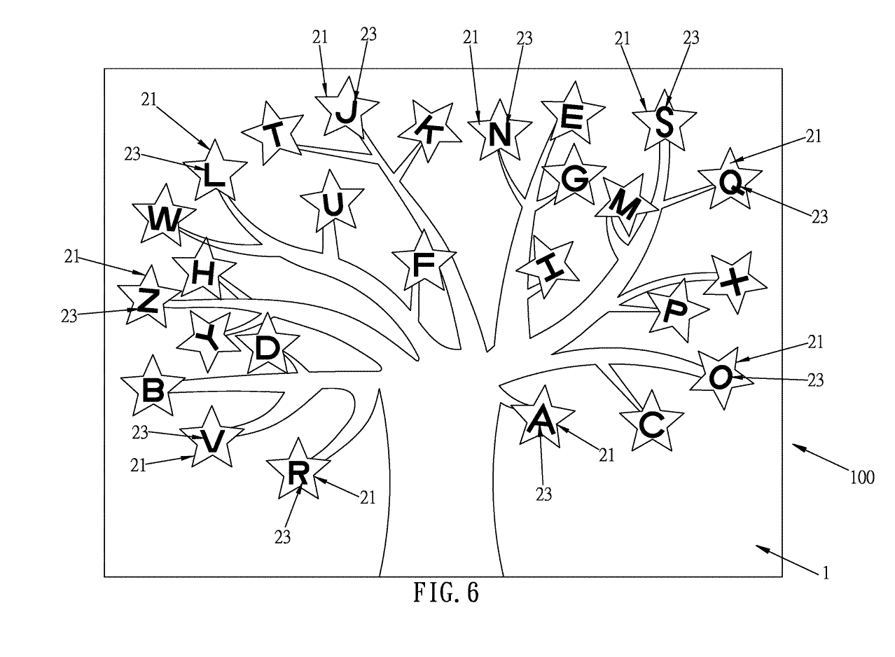

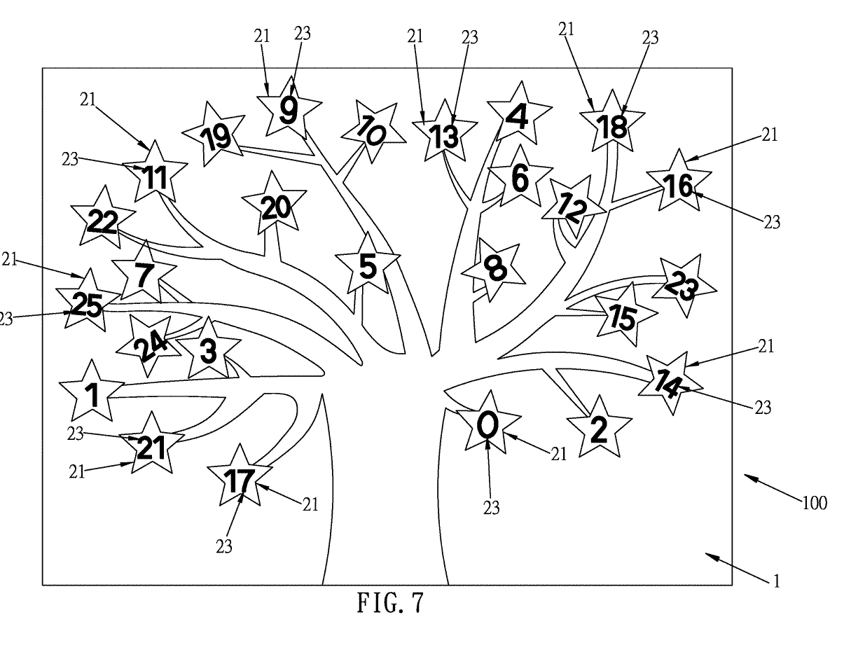

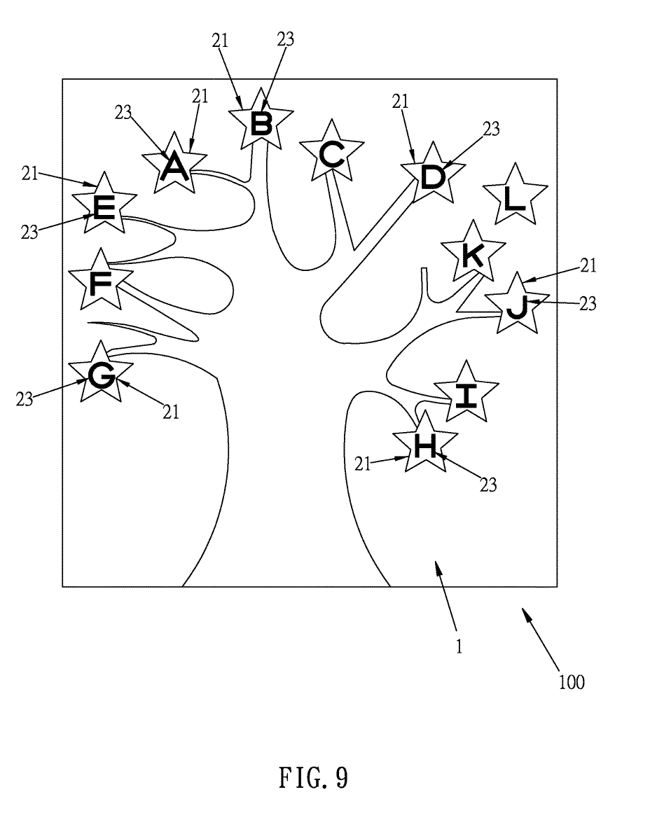

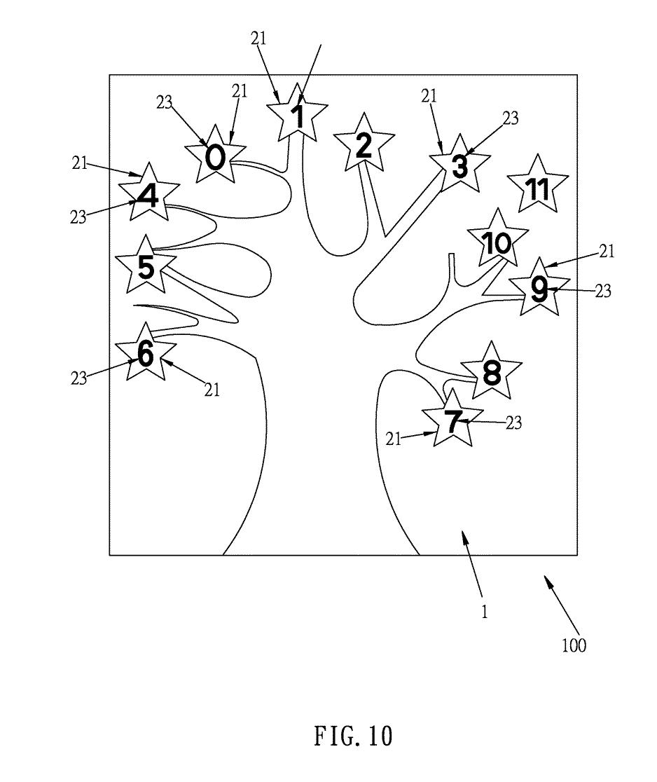

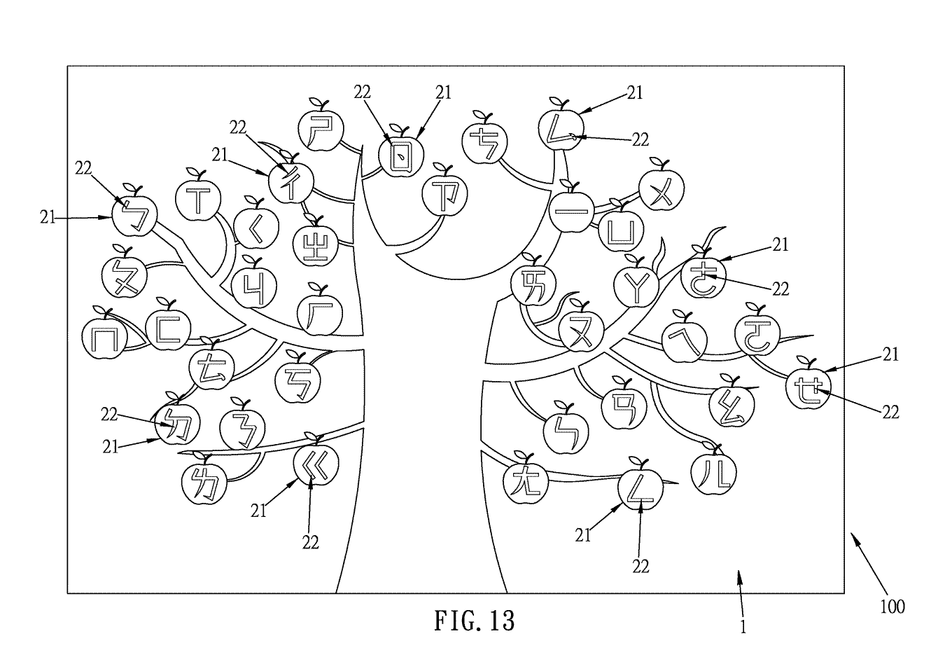

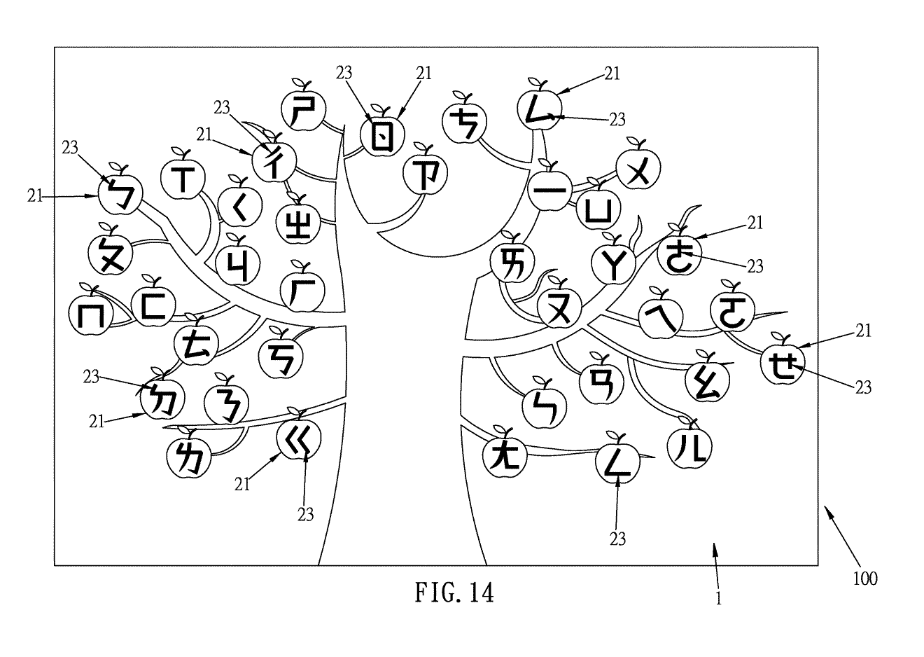

Please refer to FIGS. 1 to 14, an interactive education device 100 may comprise a first module 1 and a second module 2.

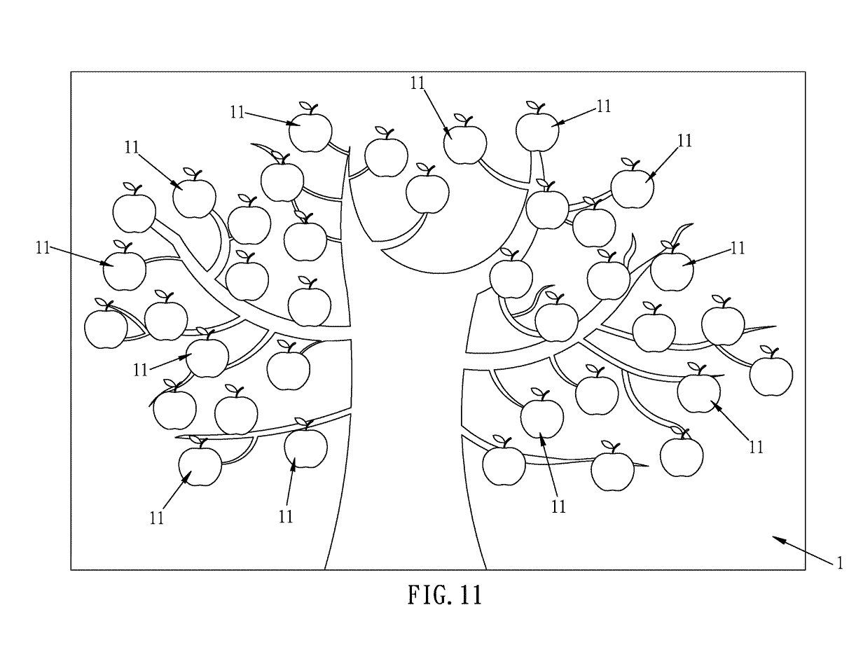

One side surface of the first module 1 has a plurality of shaped areas 11. Each of the shaped areas 11 has a first shape and arranged at a first predetermined position. Please refer to FIGS. 1 to 10, the first shape is star and the first predetermined position is each branch of a tree. Please refer to FIGS. 11 to 14, the first shape is apple-shaped and the first predetermined position is each branch of a tree. The first shape may be heart, but not limited thereto. The predetermined position may be changed according to what a designer needs.

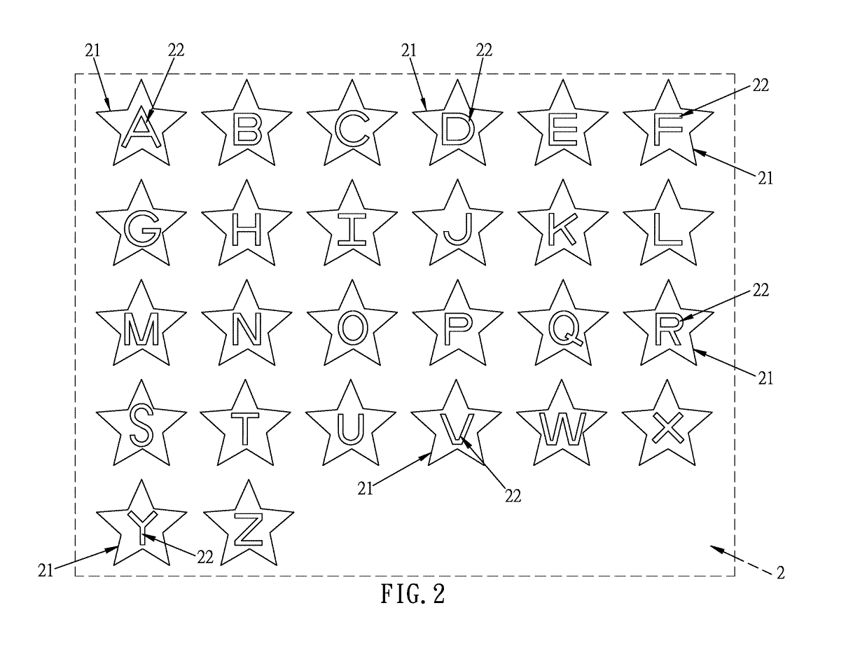

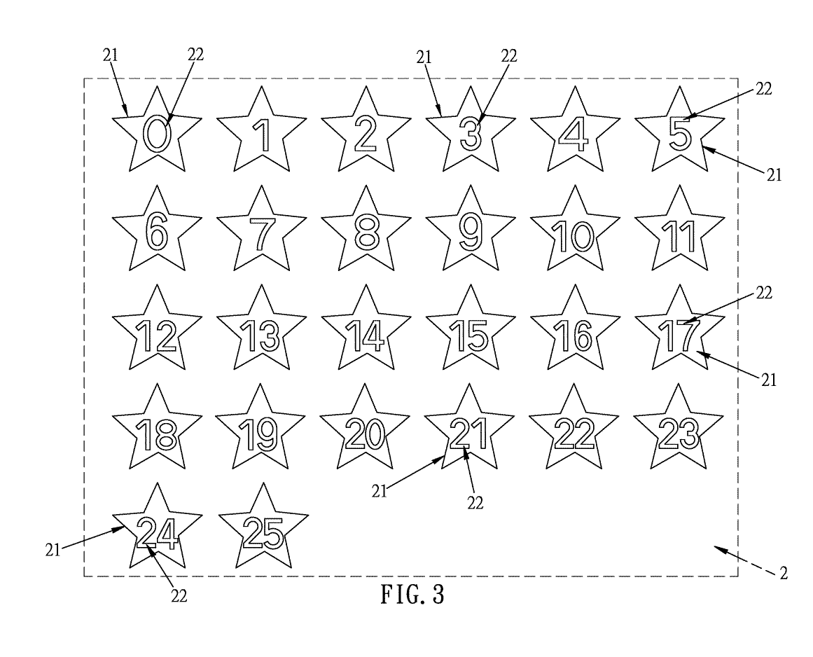

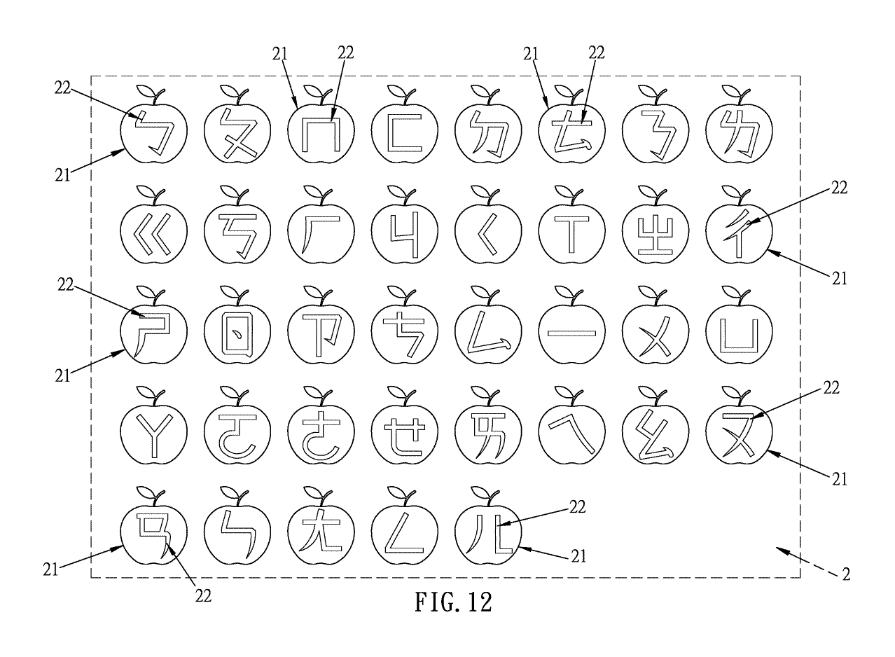

The second module 2 has a plurality of shaped blocks 21. Each of the shaped blocks 21 has a second shape. The shaped blocks 21 are respectively hollowed out a form of a written or printed character 22. The form of the written or printed character 22 of each shaped block 21 is different, and the second shape 21 is corresponding to the first shape 11. That is, if the first shape is star, the second shape is star. If the first shape is apple-shaped, the second shape is apple-shaped. The form of the written or printed character 22 may be English letter (shown as in FIG. 2), Arabic numeral (shown as in FIG. 3), or BoPoMoFo (shown as in FIG. 12). And further, the form of the written or printed character 22 may be alphabets of different countries, such as hiragana and katakana of Japan, but not limited thereto.

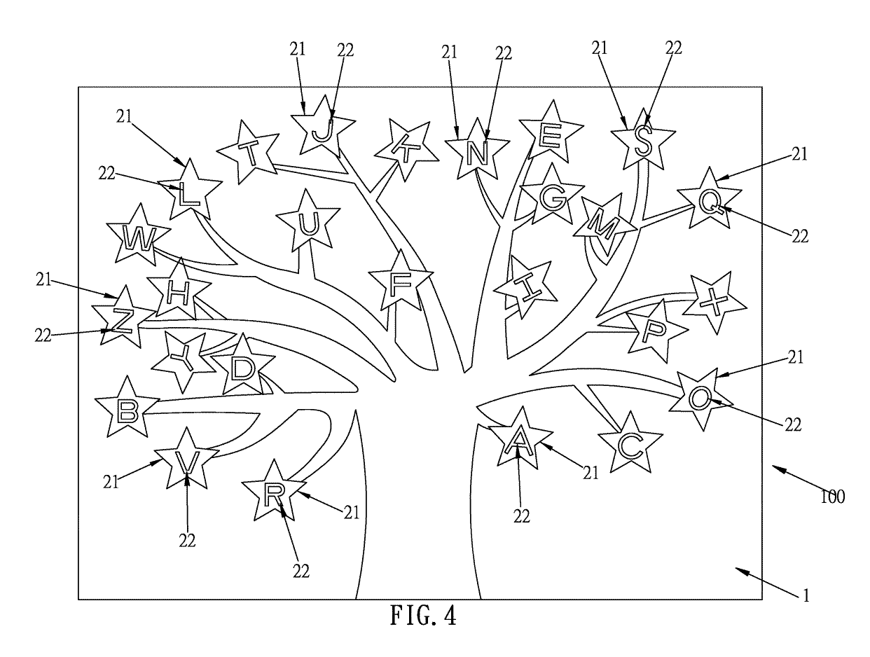

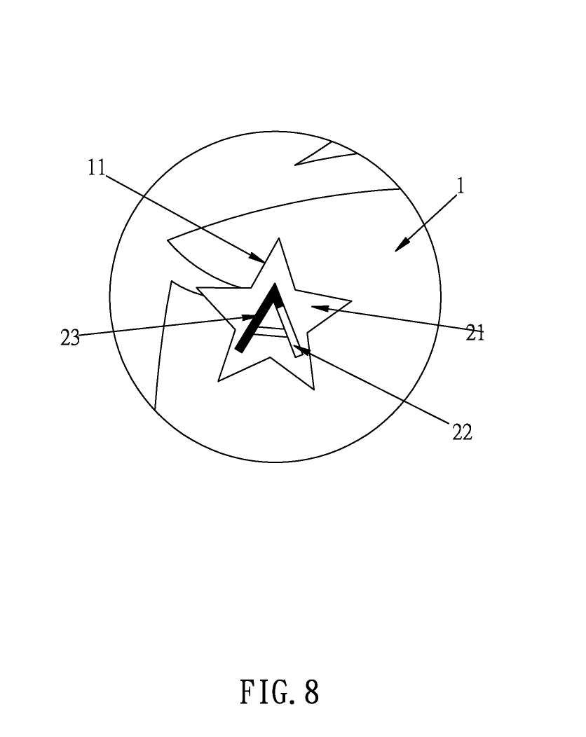

Please refer to FIGS. 4 and 8, when a tutor (such as a kindergarten teacher) teaches at least one tutee (such as a child) to put a shaped block 21 whose form of the written or printed character 22 is “A” to the shaped area 11 whose predetermined position is arranged at right side of the tree and closest to the trunk of the tree, the tutee may find the shaped block 21 whose hollowed-out form of the written or printed character 22 is “A” first and then put it to the shaped area 11 whose predetermined position is assigned by the tutor. It means that the tutee has preliminarily known the form of the written or printed character 22 which is “A”.

In order to enhance the memory and make the education more fun, the tutor may teach the tutee to use a color pen (not shown) to color the hollowed-out form of the written or printed character 22 “A”. And then, a word 23 is formed at the shaped area 11 of the predetermined position which is assigned by the tutor. Therefore, the tutee may have fun of painting and enhance to memorize and know the form of the written or printed character 22 “A” (the word 23). It may achieved the effect of education (or teaching) and further enhance to memorize and learn the written or printed character 22 (or the word 23) which the tutor wants to educate/teach.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

What is claimed is:

1. An interactive education device, comprising:
a first module, one side surface thereof has a plurality of shaped areas, each of the shaped areas has a first shape and arranged at a first predetermined position; and
a second module, having a plurality of shaped blocks, each of the shaped blocks has a second shape, the shaped blocks are respectively hollowed out a form of a written or printed character, the form of the written or printed character of each shaped block is different, and the second shape is corresponding to the first shape;
wherein a tutee is assigned to put each of the shaped blocks at the corresponding shaped area based on the form of the written or printed character and the predetermined position assigned by a tutor.

2. The interactive education device as claimed in claim 1, wherein the form of the written or printed character is English letter, Arabic numeral, BoPoMoFo, or alphabets of different countries.

3. The interactive education device as claimed in claim 1, wherein the first shape is apple-shaped, star, or heart.

4. The interactive education device as claimed in claim 1, wherein a color pen is passed through the hollowed-out form of the written or printed character to color on the shaped area to form a word while the tutee is assigned to put each of the shaped blocks at the corresponding shaped area based on the form of the written or printed character and the predetermined position assigned by the tutor.
